(19) United States
(12) Patent Application Publication
(10) Pub. No.: US 2011/0256916 A1
(43) Pub. Date: Oct. 20, 2011

(54) GAMING METHOD FOR PLAYING A CARD GAME, AND GAMING APPARATUS FOR PERFORMING THE SAME

(75) Inventor: Arden Yang, Rosemead, CA (US)

(73) Assignee: Astro Corporation, Taipei (TW)

(21) Appl. No.: 12/903,442

(22) Filed: Oct. 13, 2010

(30) Foreign Application Priority Data
Apr. 20, 2010 (TW) 099112355

(51) Int. Cl. A63F 9/24; A63F 13/00

(52) U.S. Cl. 463/11; 463/30; 463/43

(57) ABSTRACT

A gaming method for playing a card game includes the steps of: allowing a player to place a main bet and an optional side bet; dealing a virtual playing card to a player area and a dealer area; allowing the player to input a guess command or a stand command; when the player inputted the guess command, dealing another virtual playing card to the player area, and determining whether a relation between face values of a current virtual playing card and a latest previous virtual playing card that was dealt to the player area conforms with the guess command; dealing at least one virtual playing card to the dealer area when the player finished playing the card game; and resolving the side bet based upon a total number of the virtual playing cards dealt to the dealer area.

### CROSS-REFERENCE TO RELATED APPLICATION

This application claims priority of Taiwanese Application No. 099112355, filed on Apr. 20, 2010.

### BACKGROUND OF THE INVENTION

1. Field of the Invention

The present invention relates to a gaming apparatus, more particularly to a gaming apparatus adapted for performing a gaming method for playing a card game.

2. Description of the Related Art

U.S. Pat. No. 7,238,108 discloses a casino game with multiple playing modes and wagering options. The casino game incorporates at least a first compulsory playing mode and one or more optional playing modes without a house advantage. The first playing mode may be a three-, five- or seven-card poker game against a payout scale based on the respective hand poker rank or against both a payout scale and the dealer. The optional playing modes include head-to-head poker games against the dealer only and poker games against other players.

### SUMMARY OF THE INVENTION

An object of the present invention is to provide a gaming method for playing a card game with a side bet option that may sustain player interest.

Another object of the present invention is to provide a gaming apparatus for playing the card game.

Accordingly, a gaming method for playing a card game of this invention is adapted to be implemented by a gaming apparatus that includes a display unit, an input unit, a memory device storing program instructions for playing a card game, and a processing unit coupled to the display unit, the input unit and the memory device. The processing unit is operable to execute the program instructions to perform the gaming method for playing the card game. The gaming method comprises the steps of:
a) generating a gaming image that includes a player area and a dealer area, and showing the gaming image on the display unit;
b) allowing a player associated with the player area to place a main bet and an optional side bet through the input unit;
c) dealing a virtual playing card to each of the player area and the dealer area;
d) allowing the player to input one of a guess command and a stand command through the input unit;
e) when it is determined that the player inputted the guess command in step d),
   e1) dealing another virtual playing card to the player area,
   e2) determining whether a relation between a face value of a current virtual playing card that is dealt to the player area in step e1) and a face value of a latest previous virtual playing card that was dealt to the player area conforms with the guess command,
   e3) repeating steps d) and e) until it is determined that the relation between the face value of the current virtual playing card and the face value of the latest previous virtual playing card does not conform with the guess command, and
   e4) when it is determined in step e2) that the relation between the face value of the current virtual playing card and the face value of the latest previous virtual playing card does not conform with the guess command inputted in step d),
      collecting the main bet placed in step b), and
      when it is determined that the player placed the side bet in step b), dealing at least one virtual playing card to the dealer area according to a predetermined rule, and resolving the side bet placed in step b) based upon a total number of the virtual playing cards dealt to the dealer area in steps c) and e4); and
f) when it is determined that the player inputted the stand command in step d),
   f1) dealing at least one virtual playing card to the dealer area according to the predetermined rule,
   f2) resolving the main bet placed in step b) based on a total number of the virtual playing cards dealt to the player area insteps c) and e) and a total number of the virtual playing cards dealt to the dealer area in steps c) and f1), and
   f3) when it is determined by the gaming apparatus that the player placed the side bet in step b), configuring the gaming apparatus to resolve the side bet placed in step b) based on the total number of the virtual playing cards dealt to the dealer area in steps c) and f1).

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram for illustrating a preferred embodiment of a gaming apparatus for playing a card game according to the present invention;

FIGS. 2 to 4 are schematic diagrams of gaming screens to illustrate a gaming method performed by the gaming apparatus of the preferred embodiment; and

FIGS. 5 and 6 are flow charts for illustrating a gaming method for playing a card game implemented using the gaming apparatus of the preferred embodiment.

### DETAILED DESCRIPTION OF THE PREFERRED EMBODIMENT

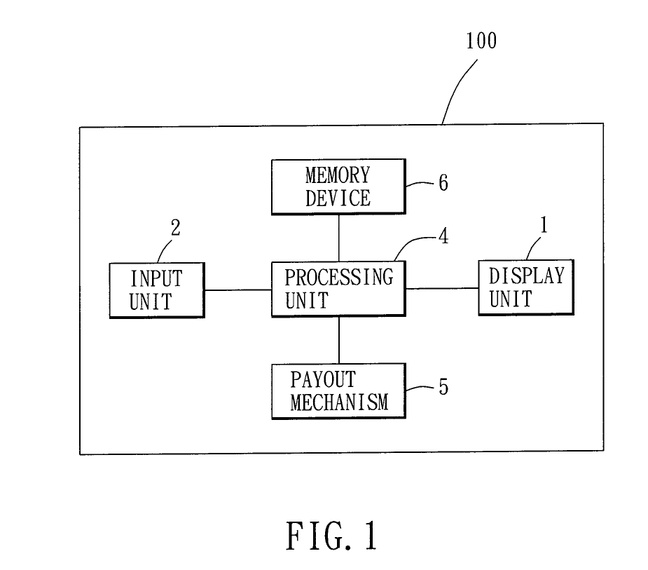

Referring to FIG. 1, the preferred embodiment of a gaming apparatus 100 for playing a card game according to this invention includes a display unit 1, an input unit 2, a processing unit 4, a payout mechanism 5, and a memory device 6. In practice, the gaming apparatus 100 may be, but is not limited to, a gaming machine or a personal computer.

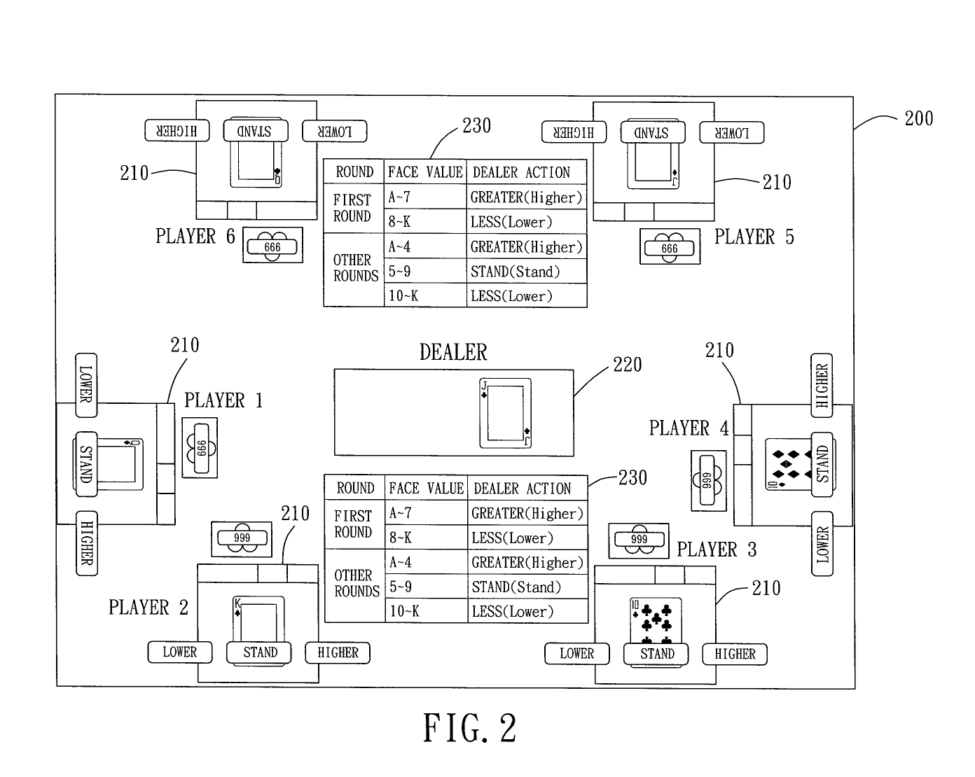

The display unit 1 may be a display device adapted to display a gaming image 200 as shown in FIGS. 2 to 4. The input unit 2 may be a keyboard, a mouse, or other peripheral devices associated with a personal computer, and is configured to allow a player to place a bet and input commands. The memory device 6 stores program instructions for playing a card game. The processing unit 4 is coupled to the display unit 1, the input unit 2 and the memory device 6, and is operable to execute the program instructions to perform a gaming method for playing the card game.

The program instructions for performing the gaming method may be stored in a machine readable storage medium of a computer program product, such as a magnetic disk or an optical disk, or a storage device of an internet server, for downloading to and installing in the memory device 6. Then, the processing unit 4 is operable to access and execute the program instructions installed in the memory device 6 to perform the gaming method. In practice, the gaming method may be applied to an on-line game or a web game, and image data (e.g., virtual chips and virtual playing cards) that are required during execution of the gaming method may be downloaded by the gaming apparatus 100 from a server through the Internet.

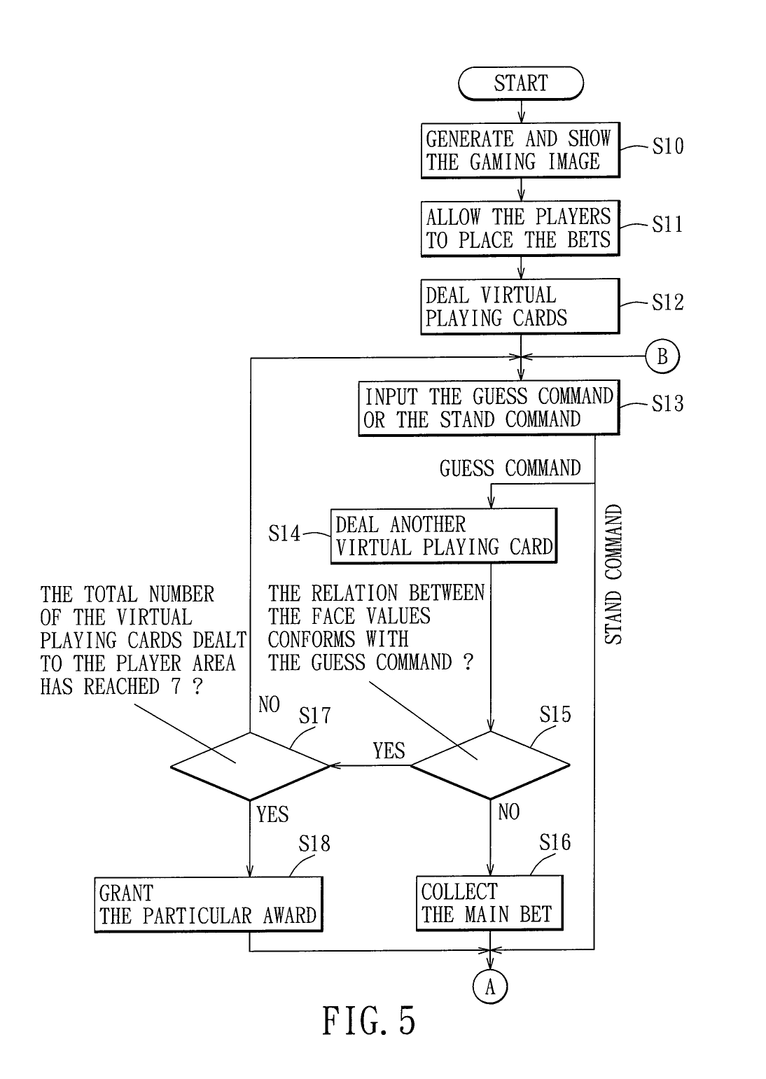

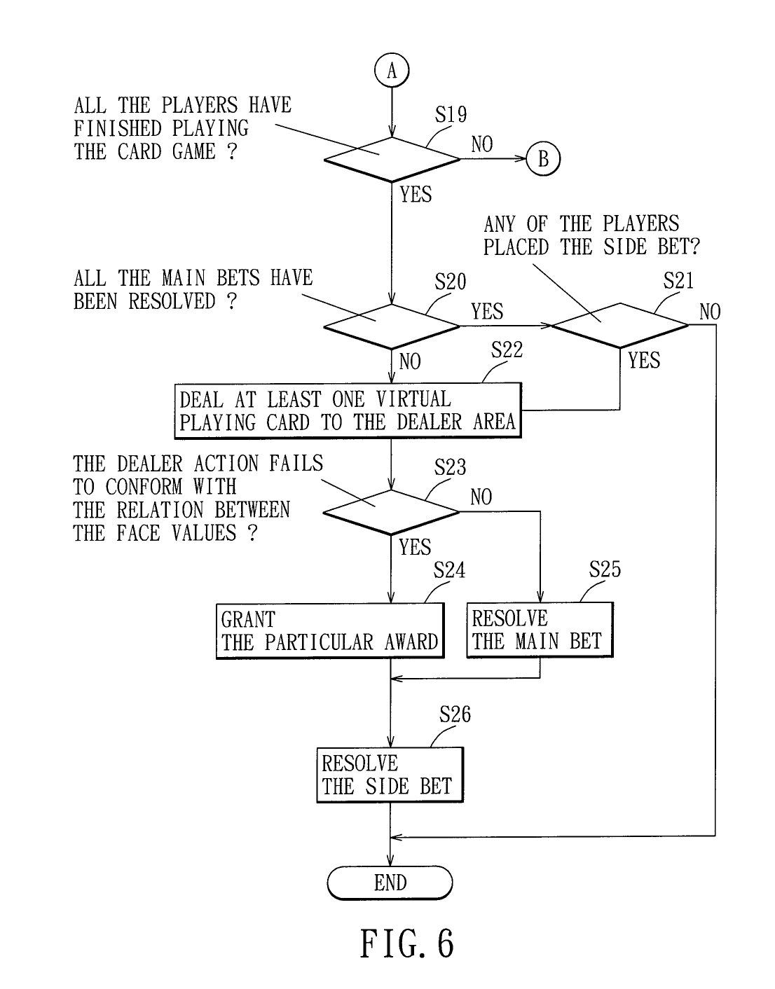

Referring to FIGS. 5 and 6, the gaming method implemented by the gaming apparatus 100 includes the following steps.

In step S10, the processing unit 4 is operable to generate the gaming image 200 that includes a plurality of player areas 210 and a dealer area 220, and to control the display unit 1 to show the gaming image 200. In this exemplary embodiment, there are six players (Player 1 to Player 6) joining the card game, and the dealer is a non-player character.

In step S11, the processing unit 4 is operable to allow each of the players associated with a respective one of the player areas 210 to place a main bet and an optional side bet through the input unit 2. After receiving a payment signal from the input unit 2, the processing unit 4 is further operable to control the display unit 1 to show on the player areas 210 the amounts of the bets placed by the players. In this embodiment, the players have to place the main bet first, and then are allowed to place the side bet. Further, the amount of the side bet must not be greater than the amount of the main bet.

As shown in FIG. 2, the processing unit 4 is operable to deal a virtual playing card shown face up to each of the player areas 210 and the dealer area 220 in step S12. Then, Players 1 to 6 are allowed to play the card game alone in sequence, and the dealer plays last.

In step S13, the processing unit 4 is operable to allow a current one of the players to input a guess command or a stand command through the input unit 2. In particular, the guess command is one of a first command for guessing that a face value of a to-be-dealt virtual playing card is greater than the face value of a latest previous virtual playing card that was dealt to the player area 210, and a second command for guessing that the face value of the to-be-dealt virtual playing card is less than the face value of the latest previous virtual playing card that was dealt to the player area 210.

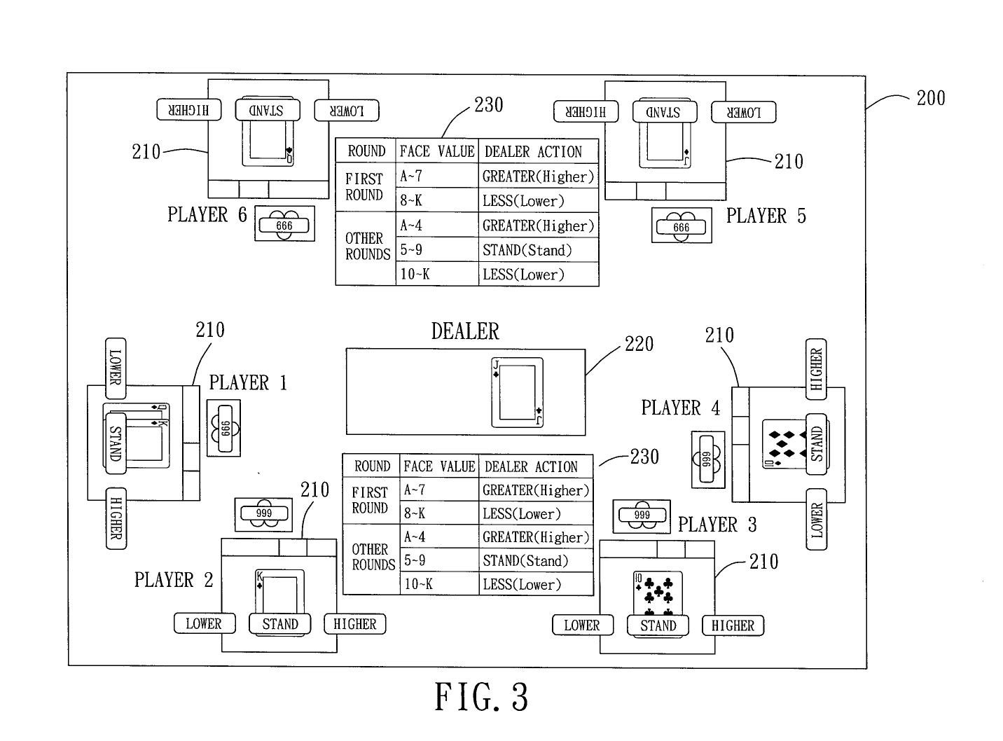

When it is determined that the player inputted the guess command in step S13, as shown in FIG. 3, the processing unit 4 is operable to deal another virtual playing card to the corresponding one of the player areas 210 that is associated with the current one of the players (Player 1) in step S14. Further, when it is determined that the player inputted the stand command in step S13, the flow goes to step S19 without dealing other virtual playing cards to the corresponding one of the player areas 210.

In step S15, the processing unit 4 is operable to determine whether a relation between a face value of a current virtual playing card that is dealt to the corresponding one of the player areas 210 in step S14 and a face value of the latest previous virtual playing card that was dealt to the corresponding one of the player areas 210 conforms with the guess command. When it is determined that the relation between the face value of the current virtual playing card and the face value of the latest previous virtual playing card conforms with the guess command, the flow goes to step S17. Otherwise, the flow goes to step S16. For instance, as shown in FIG. 3, the face value of the current virtual playing card “K” dealt to the player area 210 associated with Player 1 is greater than the face value of the latest previous virtual playing card “Q” dealt thereto. The processing unit 4 is operable to execute step S16 for collecting the main bet if Player 1 inputted the second command as the guess command in step S13, that is to say, the relation between the face value of the current virtual playing card and the face value of the latest previous virtual playing card does not conform with the guess command. On the other hand, the flow will go to step S17 if Player 1 inputted the first command as the guess command in step S13, that is to say, the relation between the face value of the current virtual playing card and the face value of the latest previous virtual playing card conforms with the guess command.

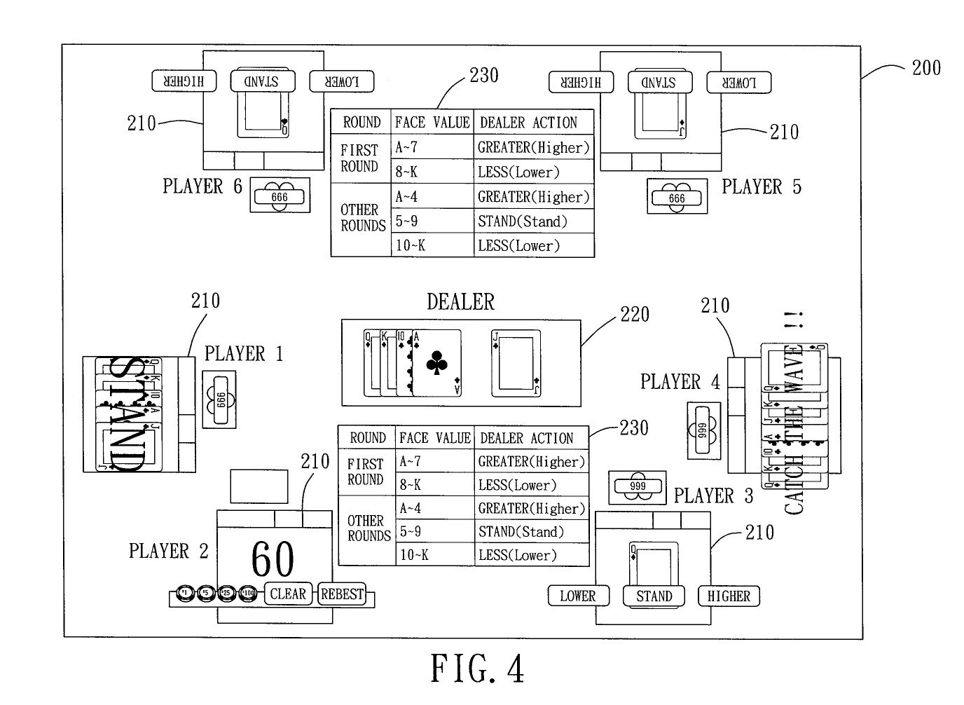

In step S17, the processing unit 4 is operable to determine whether a total number of the virtual playing cards dealt thus far to the player area 210 associated with the current one of the players in steps S12 and S14 has reached a predetermined number (e.g., 7 in this embodiment). When it is determined that the total number of the virtual playing cards dealt thus far to the player area 210 insteps S12 and S14 has yet to reach the predetermined number, the flow goes back to step S13. On the other hand, when it is determined that the total number of the virtual playing cards dealt to the player area 210 in steps S12 and S14 has reached the predetermined number, the flow goes to step S18. In step S18, the processing unit 4 is operable to control the display unit 1 to show “CATCH THE WAVE” on the player area 210 associated with the current one of the players (Player 4) as shown in FIG. 4, and to control the payout mechanism 5 to grant a particular award to the current one of the players. For example, an amount of the particular award is, but not limited to, six times the amount of the main bet.

In step S19, the processing unit 4 is operable to determine whether all of the players have finished playing the card game. When any of the players has not yet played the card game, the flow goes back to step S13 for allowing the next player to play the card game. When all of the players have finished playing the card game, the processing unit 4 is operable, in step S20, to further determine whether all of the main bets placed in step S11 have been resolved (in step S16 or S18). When the determination is affirmative in step S20, the processing unit 4 is operable to further determine whether any of the players placed the side bet in step S11. It should be noted that, in other embodiments, the processing unit 4 may be also operable to implement step S21 first, and to implement step S20 when the determination in step S21 is negative.

The card game is completed when all of the main bets have been resolved and no player placed the side bet in step S11. When it is determined in step S20 that any of the main bets has not been resolved or in step S21 that any of the players placed the side bet, the processing unit 4 is operable to execute step S22 to deal at least one virtual playing card to the dealer area 220 according to a predetermined rule shown in Table 1. In this embodiment, the predetermined rule is shown on a central area 230 of the gaming image. In other embodiments, the predetermined rule may be marked on a housing of the gaming apparatus 100.

TABLE 1

| Round | Face Value | Dealer Action |
|---|---|---|
| First Round | A~7 | Greater |
| | 8~K | Less |
| Other Rounds | A~4 | Greater |
| | 5~9 | Stand |
| | 10~K | Less |

The following description is provided for explaining details of step S22 and the predetermined rule. In a first round of the dealer action, when the face value of the virtual playing card that was dealt to the dealer area 220 in step S12 ranges from A to 7, the processing unit 4 is operable to guess that a face value of a to-be-dealt virtual playing card is greater than the face value of the virtual playing card that was dealt to the dealer area in step S12. On the other hand, when the face value of the virtual playing card that was dealt to the dealer area 220 in step S12 ranges from 8 to K, the processing unit 4 is operable to guess that a face value of a to-be-dealt virtual playing card is less than the face value of the virtual playing card that was dealt to the dealer area in step S12. Then, the processing unit 4 is operable to deal another virtual playing card to the dealer area 230.

In other rounds of the dealer action, when the face value of the latest previous virtual playing card that was dealt to the dealer area 230 in the latest previous round ranges from A to 4, the processing unit 4 is operable to guess that a face value of a to-be-dealt virtual playing card is greater than the face value of the latest previous virtual playing card that was dealt to the dealer area 230. A decision to stand is made when the face value of the latest previous virtual playing card ranges from 5 to 9. Moreover, the processing unit 4 is operable to guess that the face value of the to-be-dealt virtual playing card is less than the face value of the latest previous virtual playing card when the face value of the latest previous virtual playing card ranges from 10 to K. It should be noted that the predetermined rule is not limited to the disclosure of this embodiment.

The processing unit 4 is operable to repeat step S22 until the decision to stand is made, or the dealer action does not conform with the relation between the face value of the current virtual playing card and the face value of the latest previous virtual playing card. Subsequently, in step S23, the processing unit 4 is operable to determine whether the dealer action in step S22 fails to conform with the relation between the face value of the current virtual playing card and the face value of the latest previous virtual playing card.

In step S24, when the determination made in step S23 is affirmative, the players whose main bets have yet to be resolved are deemed winners of the card game, and the processing unit 4 is operable to control the payout mechanism 5 to grant a respective main award to such players based on a total number of the virtual playing cards dealt to the player areas 210 associated with such players in steps S12 and S14. Otherwise, the flow goes to step S25 for resolving the main bet. In step S25, the processing unit 4 is operable to collect the main bet when a total number of the virtual playing cards dealt to the dealer area 220 is greater than the total number of the virtual playing cards dealt to the player area 210 associated with the player who placed the main bet, to grant the main award when the total number of the virtual playing cards dealt to the dealer area 220 is less than the total number of the virtual playing cards dealt to the player area 210 associated with the player who placed the main bet, and to return the main bet when the total number of the virtual playing cards dealt to the dealer area 220 is equal to the total number of the virtual playing cards dealt to the player area 210 associated with the player who placed the main bet. With reference to Table 2, the amount of the main award is determined based on the total number of the virtual playing cards dealt to the player area 210.

TABLE 2

| Total Number of The | |
|---|---|
| Virtual Playing Cards | Amount of The Main Award |
| 1 | Equal to The Main Bet |
| 2 | Equal to The Main Bet |
| 3 | Equal to The Main Bet |
| 4 | Equal to The Main Bet |
| 5 | 2 Times of The Main Bet |
| 6 | 3 Times of The Main Bet |

When it is determined in step S21 that any of the players placed the side bet in step S11, the processing unit 4 is operable, in step S26, to resolve the side bet. With reference to Table 3, when the total number of the virtual playing cards dealt to the dealer area 220 is less than 3, the processing unit 4 is operable to collect the side bet. When the total number of the virtual playing cards dealt to the dealer area 220 is greater than or equal to 3, the processing unit 4 is operable to grant a special award based on the total number of the virtual playing cards dealt to the dealer area 220.

TABLE 3

| Total Number of The | |
|---|---|
| Virtual Playing Cards | Amount of The Special Award |
| 1 | Collect The Side Bet |
| 2 | Collect The Side Bet |
| 3 | 2 Times of The Side Bet |
| 4 | 3 Times of The Side Bet |
| 5 | 4 Times of The Side Bet |
| 6 | 7 Times of The Side Bet |
| 7 | 20 Times of The Side Bet |

It should be noted that, when the guess command or the dealer action does not conform with the relation between the face values, the total number of the virtual playing cards dealt either to the player area 210 or to the dealer area 220 does not include the latest virtual playing card that was dealt to the player area 210 or the dealer area 220. Further, the amount of the main award is not limited to the disclosure in Table 2, and may vary according to design requirements.

In summary, the gaming method of this invention provides players with an optional side bet that may sustain player interest. Further, since the dealer action follows the predetermined rule that is known to the players, the players may be enticed to join the card game in view of the higher probability of gaining an award.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A gaming method for playing a card game, said gaming method being adapted to be implemented by a gaming apparatus and comprising the steps of:
a) configuring the gaming apparatus to generate a gaming image that includes a player area and a dealer area;
b) configuring the gaming apparatus to allow a player associated with the player area to place a main bet and an optional side bet;
c) configuring the gaming apparatus to deal a virtual playing card to each of the player area and the dealer area;
d) configuring the gaming apparatus to allow the player to input one of a guess command and a stand command;
e) when it is determined by the gaming apparatus that the player inputted the guess command in step d),
e1) configuring the gaming apparatus to deal another virtual playing card to the player area,
e2) configuring the gaming apparatus to determine whether a relation between a face value of a current virtual playing card that is dealt to the player area in step e1) and a face value of a latest previous virtual playing card that was dealt to the player area conforms with the guess command,
e3) configuring the gaming apparatus to repeat steps d) and e) until the gaming apparatus determines that the relation between the face value of the current virtual playing card and the face value of the latest previous virtual playing card does not conform with the guess command, and
e4) when the gaming apparatus determines in step e2) that the relation between the face value of the current virtual playing card and the face value of the latest previous virtual playing card does not conform with the guess command inputted in step d),
configuring the gaming apparatus to collect the main bet placed in step b), and
when it is determined by the gaming apparatus that the player placed the side bet in step b), configuring the gaming apparatus to deal at least one virtual playing card to the dealer area according to a predetermined rule, and to resolve the side bet placed in step b) based on a total number of the virtual playing cards dealt to the dealer area in steps c) and e4); and
f) when it is determined by the gaming apparatus that the player inputted the stand command in step d),
f1) configuring the gaming apparatus to deal at least one virtual playing card to the dealer area according to the predetermined rule,
f2) configuring the gaming apparatus to resolve the main bet placed in step b) based on a total number of the virtual playing cards dealt to the player area in steps c) and e) and a total number of the virtual playing cards dealt to the dealer area in steps c) and f1), and
f3) when it is determined by the gaming apparatus that the player placed the side bet in step b), configuring the gaming apparatus to resolve the side bet placed in step b) based on the total number of the virtual playing cards dealt to the dealer area in steps c) and f1).

2. The gaming method as claimed in claim 1, wherein, in step d), the guess command is one of a first command for guessing that a face value of a to-be-dealt virtual playing card is greater than the face value of the latest previous virtual playing card that was dealt to the player area, and a second command for guessing that the face value of the to-be-dealt virtual playing card is less than the face value of the latest previous virtual playing card that was dealt to the player area.

3. The gaming method as claimed in claim 1, wherein, in step e3), the gaming apparatus is configured to repeat steps d) and e) until the gaming apparatus determines that the relation between the face value of the current virtual playing card and the face value of the latest previous virtual playing card does not conform with the guess command, and as long as the total number of the virtual playing cards dealt to the player area in steps c) and e) has yet to reach a predetermined number; and
step e) further includes:
e5) when the gaming apparatus determines in step e2) that the relation between the face value of the current virtual playing card and the face value of the latest previous virtual playing card conforms with the guess command inputted in step d), and further determines that the total number of the virtual playing cards dealt to the player area in steps c) and e) has reached the predetermined number,
configuring the gaming apparatus to grant an award to the player to thereby resolve the main bet, and
when it is determined by the gaming apparatus that the player placed the side bet in step b), configuring the gaming apparatus to deal at least one virtual playing card to the dealer area according to a predetermined rule, and to resolve the side bet placed in step b) based on a total number of the virtual playing cards dealt to the dealer area in steps c) and e4).

4. The gaming method as claimed in claim 1, wherein, in steps e4) and f3), the gaming apparatus is configured to grant an award to the player to thereby resolve the side bet when the total number of the virtual playing cards dealt to the dealer area is greater than or equal to a predetermined number, and to collect the side bet when the total number of the virtual playing cards dealt to the dealer area is smaller than the predetermined number.

5. The gaming method as claimed in claim 4, wherein an amount of the award is equal to a product of the side bet and a multiplier that is determined according to the total number of the virtual playing cards dealt to the dealer area.

6. The gaming method as claimed in claim 5, wherein, in steps e4) and f3), the gaming apparatus is configured to exclude the current virtual playing card during counting of the total number of the virtual playing cards dealt to the dealer area.

7. The gaming method as claimed in claim 1, wherein, in steps e4) and f1), the gaming apparatus is configured to determine whether a virtual playing card is to be dealt to the dealer area according to the predetermined rule with reference to a face value of a latest previous virtual playing card that was dealt to the dealer area.

8. The gaming method as claimed in claim 1, wherein, in step f2), the gaming apparatus is configured to grant an award to the player when the gaming apparatus determines that the total number of the virtual playing cards dealt to the player area in steps c) and e) is greater than the total number of the virtual playing cards dealt to the dealer area in steps c) and f).

9. The gaming method as claimed in claim 8, wherein, in step f2), the award granted to the player is based on the main bet and the total number of the virtual playing cards dealt to the player area in steps c) and e).

10. A computer program product comprising a machine readable storage medium having program instructions stored therein which when executed cause a computer to perform a gaming method for playing a card game according to claim 1.

11. A gaming apparatus for playing a card game, comprising:
a display unit;
an input unit;
a memory device storing program instructions for playing a card game; and
a processing unit coupled to said display unit, said input unit, and said memory device, and operable to execute the program instructions to perform a gaming method for playing the card game, the gaming method including the steps of:
a) generating a gaming image that includes a player area and a dealer area, and showing the gaming image on said display unit;
b) allowing a player associated with the player area to place a main bet and an optional side bet through said input unit;
c) dealing a virtual playing card to each of the player area and the dealer area;
d) allowing the player to input one of a guess command and a stand command through said input unit;
e) when it is determined that the player inputted the guess command in step d),
e1) dealing another virtual playing card to the player area,
e2) determining whether a relation between a face value of a current virtual playing card that is dealt to the player area in step e1) and a face value of a latest previous virtual playing card that was dealt to the player area conforms with the guess command,
e3) repeating steps d) and e) until it is determined that the relation between the face value of the current virtual playing card and the face value of the latest previous virtual playing card does not conform with the guess command,
e4) when it is determined in step e2) that the relation between the face value of the current virtual playing card and the face value of the latest previous virtual playing card does not conform with the guess command inputted in step d),
collecting the main bet placed in step b), and
when it is determined that the player placed the side bet in step b), dealing at least one virtual playing card to the dealer area according to a predetermined rule, and resolving the side bet placed in step b) based on a total number of the virtual playing cards dealt to the dealer area in steps c) and e4); and
f) when it is determined that the player inputted the stand command in step d),
f1) dealing at least one virtual playing card to the dealer area according to the predetermined rule,
f2) resolving the main bet placed in step b) based on a total number of the virtual playing cards dealt to the player area in steps c) and e) and a total number of the virtual playing cards dealt to the dealer area in steps c) and f1), and
f3) when it is determined that the player placed the side bet in step b), resolving the side bet placed in step b) based on the total number of the virtual playing cards dealt to the dealer area in steps c) and f1).

12. The gaming apparatus as claimed in claim 11, wherein, in step d), the guess command is one of a first command for guessing that a face value of a to-be-dealt virtual playing card is greater than the face value of the latest previous virtual playing card that was dealt to the player area, and a second command for guessing that the face value of the to-be-dealt virtual playing card is less than the face value of the latest previous virtual playing card that was dealt to the player area.

13. The gaming apparatus as claimed in claim 11, wherein, in step e3), said processing unit is operable to repeat steps d) and e) until said processing unit determines that the relation between the face value of the current virtual playing card and the face value of the latest previous virtual playing card does not conform with the guess command, and as long as the total number of the virtual playing cards dealt to the player area in steps c) and e) has yet to reach a predetermined number; and
step e) further includes:
e5) when it is determined in step e2) that the relation between the face value of the current virtual playing card and the face value of the latest previous virtual playing card conforms with the guess command inputted in step d), and further that the total number of the virtual playing cards dealt to the player area in steps c) and e) has reached the predetermined number,
granting an award to the player to thereby resolve the main bet, and
when it is determined that the player placed the side bet in step b), dealing at least one virtual playing card to the dealer area according to a predetermined rule, and resolving the side bet placed in step b) based on a total number of the virtual playing cards dealt to the dealer area in steps c) and e4).

14. The gaming apparatus as claimed in claim 11, wherein, in steps e4) and f3), said processing unit is operable to grant an award to the player to thereby resolve the side bet when the total number of the virtual playing cards dealt to the dealer area is greater than or equal to a predetermined number, and to collect the side bet when the total number of the virtual playing cards dealt to the dealer area is smaller than the predetermined number.

15. The gaming apparatus as claimed in claim 14, wherein an amount of the award is equal to a product of the side bet and a multiplier that is determined according to the total number of the virtual playing cards dealt to the dealer area.

16. The gaming apparatus as claimed in claim 15, wherein, in steps e4) and f3), said processing unit is operable to exclude the current virtual playing card during counting of the total number of the virtual playing cards dealt to the dealer area.

17. The gaming apparatus as claimed in claim 11, wherein, in steps e4) and f1), said processing unit is operable to determine whether a virtual playing card is to be dealt to the dealer area according to the predetermined rule with reference to a face value of a latest previous virtual playing card that was dealt to the dealer area.

18. The gaming apparatus as claimed in claim 11, wherein, in step f2), said processing unit is operable to grant an award to the player when the gaming apparatus determines that the total number of the virtual playing cards dealt to the player area in steps c) and e) is greater than the total number of the virtual playing cards dealt to the dealer area in steps c) and f).

19. The gaming apparatus as claimed in claim 18, wherein, in step f2), the award granted to the player is based on the main bet and the total number of the virtual playing cards dealt to the player area in steps c) and e).
